(19) United States
(12) Patent Application Publication
(10) Pub. No.: US 2022/0246363 A1
(43) Pub. Date: Aug. 4, 2022

(54) SUPERCAPACITOR

(71) Applicant: VOLTA PTY LTD, Scarborough (AU)

(72) Inventors: Dusan LOSIC, Seaford Rise (AU); Mahmoud Moussa, Ingle Farm (AU); Deepak DUBAL, New Farm (AU)

(21) Appl. No.: 17/599,306

(22) PCT Filed: Mar. 27, 2020
(86) PCT No.: PCT/AU2020/050294

§ 371 Date: Sep. 28, 2021

(30) Foreign Application Priority Data
Mar. 29, 2019 (AU) 2019 901067

(51) Int. Cl. H01G 11/36; H01G 11/06; H01G 11/60; H01G 11/64; H01G 11/50

(52) U.S. Cl. CPC H01G 11/36; H01G 11/06; H01G 11/50; H01G 11/64; H01G 11/60

(57) ABSTRACT

A lithium-ion hybrid supercapacitor comprising (i) an electrode comprising nitrogen-doped carbon nanotubes (N-CNTs), and (ii) an electrode comprising an electrically conductive graphene material. The supercapacitor can comprise an electrolyte which is a solution of (i) a lithium salt selected from Li[PF₂(C₂O₄)2], Li[SO₃CF₃], Li[N(CF₃SO₂)₂], Li[C(CF₃SO₂)₃], Li[N(SO₂C₂F₅)₂], LiClO₄, LiPF₆, LiAsF₆, LiBF₄, LiB(C₆F₅)₄, LiB(C₆H₅)₄, Li[B(C₂O₄)₂], Li[BF₂(C₂O₄)], and a mixture of any two or more thereof, and (ii) a solvent selected form dimethyl carbonate (DMC), ethyl methyl carbonate (EMC), diethyl carbonate (DEC), methyl propyl carbonate (MPC), ethyl propyl carbonate (EPC), ethylene carbonate (EC), propylene carbonate (PC), and a mixture of any two or more thereof

### CROSS REFERENCE TO RELATED APPLICATIONS

This application is a 35 U.S.C. § 371 National Stage filing of International Application No. PCT/AU2020/050294 filed Mar. 27, 2020, which claims the benefit of priority to Australian Patent Application No. AU2019901067 filed on Mar. 29, 2019, entitled SUPERCAPACITOR, the contents of each of which are herein incorporated by reference in their entirety.

### FIELD OF THE INVENTION

The invention relates generally to supercapacitors, and in particular to lithium-ion supercapacitors.

### BACKGROUND OF THE INVENTION

Rechargeable lithium-ion batteries are ubiquitous energy storage media used in modern era devices. Conventional rechargeable batteries can offer high energy density for powering most common devices. However, the power they can generate is inherently limited.

In that context, supercapacitors have attracted intense attention due to their higher power density and longer lifecycle over rechargeable batteries. As such, supercapacitors may represent a valid alternative to conventional rechargeable lithium-ion batteries for applications requiring rapid power delivery and recharging, such as regenerative braking, short-term energy storage, hybrid electric vehicles, large industrial equipment, and portable devices. However, commercially available supercapacitors have much less energy density than rechargeable batteries, which severely limit their potential for many applications.

Accordingly, there remains an opportunity to therefore address or ameliorate one or more disadvantage or shortcoming associated with current energy storage media.

### SUMMARY OF THE INVENTION

The present invention provides a lithium-ion hybrid supercapacitor comprising (i) an electrode comprising nitrogen-doped carbon nanotubes (N-CNTs), and (ii) an electrode comprising an electrically conductive graphene material.

The supercapacitor of the invention is “hybrid” in the sense it combines (i) pseudo-capacitive characteristics associated with the electrode comprising N-CNTs (functioning as anode during discharge) and (ii) the capacitive electric double layer functionality of the electrode comprising electrically conductive graphene material (functioning as cathode during discharge). As such, the supercapacitor of the invention advantageously combines the functionality of a battery-type electrode and a supercapacitor-type electrode, in that it can provide high energy density associated with battery-type electrodes as well as high power density and long cycle life associated with capacitive electrodes.

By one of the electrodes comprising carbon nanotubes, the electrode is characterised by high surface area for the exchange of charged species. In addition, presence of nitrogen doping can improve the electrochemical properties of the nanotubes due to the stronger nitrogen-lithium interaction. In particular, N-CNTs can advantageously increase the electrode surface area in favour of stronger pseudo-capacitance without compromising the electrical conductivity of the carbon nanotubes.

In some embodiments, the N-CNTs have an atomic content of nitrogen of at least about 8%. High content of nitrogen can advantageously enhance the electrical conductivity, as well as increase the amount of defect sites to offer extra lithium-ion storage. Further, high content of graphitic nitrogen can enhance the reactivity, electrical conductivity and the transfer of lithium ions during charge/discharge cycles, which is beneficial to improving the overall rate capability of the hybrid supercapacitor.

The specific geometric characteristics of the N-CNTs are believed to play a significant role in providing the electrode with superior capacitive attributes. In some embodiments, the N-CNTs have an average axial length of at least 3 μm. In those instances, the electrode can show improved electrochemical properties such as high reversible capacity, excellent rate capability and long-term cycle-life.

By one of the electrodes comprising an electrically conductive graphene material, the electrode is characterised by high electric conductivity and significant specific area. This ensures the electrode serves as an extensive transport platform for electrolytes. Also, the high conductivity of the electrically conductive graphene material sheets enables a low diffusion resistance, therefore contributing to enhanced power and energy density.

Further aspects and embodiments of the invention are described in more detail below.

### BRIEF DESCRIPTION OF THE DRAWINGS

Embodiments of the invention will be now described with reference to the following non-limiting drawings, in which:

FIG. 1 shows a schematic of a preparation procedure of N-CNTs,

FIG. 2 shows Scanning Electron Microscope (SEM) images of as-synthesized polyaniline nanotubes (PANi-NT) and N-CNTs (FIGS. 2(a) and 2(c), scale bar 1 μm), and Transmission Electron Microscope (TEM) images of PANi-NT and N-CNTs (FIGS. 2(b) and 2(d), scale bar 200 nm),

FIG. 3 shows X-ray diffraction (XRD) patterns measured on a PANi-NT sample and a N-CNTs sample,

FIG. 4 shows a schematic half-cell setup used to test the electrochemical characteristics of the electrode comprising N-CNTs, using lithium as the cathode electrode,

FIG. 5 shows cyclic voltametric response of an embodiment N-CNTs electrode functioning as anode in half-cell configuration against a lithium cathode electrode,

FIG. 6 shows the rate capability of an embodiment N-CNTs electrode functioning as anode in half-cell configuration against a lithium cathode electrode,

FIG. 7 shows the cyclic stability of an embodiment N-CNTs electrode functioning as anode in half-cell configuration against a lithium cathode electrode,

FIG. 8 shows cyclic voltammetry response of an embodiment of an embodiment reduced graphene oxide (rGO) electrode functioning as cathode in half-cell configuration against a lithium anode electrode,

FIG. 9 shows the rate capability of an embodiment rGO electrode functioning as cathode in half-cell configuration against a lithium anode electrode,

FIG. 10 shows the cyclic stability of an embodiment rGO electrode functioning as cathode in half-cell configuration against a lithium anode electrode

FIG. 11 shows the combined CV curves of NCNTs and rGO electrodes in the 0.01-2.5 V and 1.5 V-4.5 V ranges (vs Li/Li+),

FIG. 12 shows a CV curve measured on an embodiment hybrid supercapacitor in full-cell configuration,

FIG. 13 shows galvanostatic charge/discharge curves for an embodiment hybrid supercapacitor in full-cell configuration at 0.45 A/g current density,

FIG. 14 shows galvanostatic charge/discharge curves for an embodiment hybrid supercapacitor in full-cell configuration at 9 A/g current density,

FIG. 15 shows the capacity retention of an embodiment hybrid supercapacitor in full-cell configuration during 4,000 charge/discharge cycles, and

FIG. 16 shows a Ragone plot comparing the energy and power density of embodiment hybrid supercapacitors in full-cell configuration relative to corresponding values reported for a number of existing devices.

### DETAILED DESCRIPTION OF THE INVENTION

The present invention provides a lithium-ion hybrid supercapacitor.

As used herein, the term “supercapacitor” means a device that is capable to store energy by charging electrical double layers through highly reversible ion adsorption on the surface of its electrodes. Specifically, in a supercapacitor electrical energy is stored at least in part in the form of double-layers of electrical charges, where one layer is charge provided by an electrode material and the other a layer is charge provided by ions from an adjacent electrolyte. Compared with a traditional dielectric capacitor, a supercapacitor can provide higher energy density while maintaining a high power output, and generally possess specific energy densities greater than 100 Wh/kg and are capable of delivering specific power densities in excess of 10,000 W/kg.

By being “hybrid”, the supercapacitor of the invention has dissimilar electrodes. In particular, the supercapacitor of the invention functions as an asymmetric cell having a pseudo-capacitive Faradaic electrode and a capacitive electric double layer electrode. By the hybrid supercapacitor being a “lithium-ion” hybrid supercapacitor is meant that double-layers of electrical charges form on the surface of the electrodes due to mobile lithium ions adsorbing on the electrode that operates as the negative electrode (i.e. anode electrode).

The supercapacitor of the invention has an electrode comprising nitrogen-doped carbon nanotubes (N-CNTs). As used herein, the expression “carbon nanotube” refers to tubular graphite. Typically, carbon nanotubes have a diameter of less than about 250 nm. The expression is used in its broadest sense to encompass single-wall carbon nanotubes (SWCN), in which the CNT is in the form of a single tubular graphite layer, and multi-walled carbon nanotubes (MWCN), in which the CNT is in the form of at least two co-axial tubular graphite layers. By a CNT being “nitrogen-doped”, at least a portion of the carbon sites in the graphitic structure of the CNT is filled with nitrogen atoms instead of with carbon atoms. Typically, the portion of carbon sites so filled with nitrogen would be detectable by common analytical means known in the art such as, for example, X-ray Photoelectric Spectroscopy (XPS).

Without wanting to be confined by theory, the role of nitrogen in the N-CNTs is believed to be pivotal for the storage of lithium ions. In that regard, nitrogen substitution creates defects in the CNT walls allowing for lithium ions to diffuse into the N-CNT cylindrical structure. In addition, the high electronegative nature of nitrogen makes it a good candidate for the provision of adsorption sites for lithium ions on the walls of the CNTs.

Accordingly, it will be understood the electrode comprising N-CNTs functions as a negative electrode, i.e. as an anode. As used herein, and as a person skilled in the art would know, the expression “negative electrode” refers to an electrode at which electrons leave the supercapacitor during discharge. For example, in the context of the supercapacitor of the present invention the negative electrode refers to the electrode at which electrons leave the supercapacitor during discharge as a consequence of an interaction between the electrode and the lithium-ions. By reference to its functionality during discharge, the negative electrode is also commonly referred to in the art as an “anode”.

There is no particular limitation on the amount of nitrogen in the N-CNTs, provided the electrode functions as intended. For example, the N-CNT may have an amount of nitrogen of at least about 5 at. %. In some embodiments, the N-CNT have an amount of nitrogen of at least about 6 at. %, at least about 8 at. %, at least about 10 at. %, at least about 15 at. %, at least about 20 at. %, or at least about 40 at. %. In some embodiments, the N-CNT have an amount of nitrogen of from about 5 at. % to about 50 at. %, for example from about 5 at. % to about 25 at. %, or from about 5 at. % to about 15 at. %.

When the amount of nitrogen in the N-CNT is high, for example larger than about 10 at. %, the electrical conductivity of the electrode is particularly enhanced, as well as the amount of defect sites in the nanotube to offer extra lithium-ion storage. Further, high content of graphitic nitrogen can enhance the reactivity, electrical conductivity and the transfer of lithium ions during charge/discharge, which is beneficial to improving the rate capability and capacity of the hybrid supercapacitor.

The N-CNTs may have any average diameter that is compatible with maintaining structural integrity of the N-CNTs. For example, the N-CNTs may have an average largest diameter in a range from about 1 nm to about 500 nm. In some embodiments, the N-CNTs have an average largest diameter from about 1 nm to about 10 nm, including about 1, about 2, about 3, about 4, about 5, about 6, about 7, about 8, about 9, and about 10 nm, and fractions thereof. In some embodiments, the N-CNTs have an average largest diameter in a range from about 10 nm to about 50 nm, including about 10, about 20, about 30, about 40 and about 50 nm, and including all values in between and fractions thereof. In some embodiments, the CNTs of the nanoporous network have an average largest diameter in a range from about 50 nm to about 500 nm, including about 50, about 100, about 150, about 200, about 250, about 300, about 350, about 400, about 450, and about 500, including all values in between and fractions thereof.

The N-CNTs may be of any average axial length that is compatible with maintaining structural integrity of the N-CNTs. In some embodiments, the N-CNTs have an average axial length of at least about 1 μm. In some embodiments, the N-CNTs have an average axial length of from about 1 μm to about 20 μm, for example from about 1 μm to about 15 μm, from about 1 μm to about 10 or from about 1 μm to about 5 μm. When the average axial length of the N-CNTs is high, for example above 1 μm, the electrode can show improved electrochemical properties such as high reversible capacity, excellent rate capability and long-term cycle-life.

In some embodiments, the N-CNTs have an average axial length of at least about 1 μm and an amount of nitrogen of at least about 10 at. %. The combination of long N-CNTs and high nitrogen content is believed to offer increase in the electrode surface area in favour of stronger pseudo-capacitance without compromising the electrical conductivity of the nanotubes. Without being confined by theory, it is believed this is because N-doping can introduce charge-transferring sites through doping-induced charge modulation, thereby improving the electrical conductivity of the nanotubes. This advantageously results in improved specific capacitance along with an enhanced energy density.

In the hybrid supercapacitor of the invention electrons may be transported to and from the electrode comprising N-CNTs by any means known to a skilled person. For example, the electrode comprising N-CNTs may be associated with an electrically conductive current collector to facilitate the flow of electrons between the electrode and an external circuit connected to the hybrid supercapacitor. A suitable current collector may comprise a metal structure, such as a metal foil or a metal grid onto which the N-CNTs are provided in electrical contact. In that regard, the current collector may be made of any material suitable to conduct electricity. In some embodiments, the electrode comprising N-CNTs also comprises a current collector formed from at least one of nickel, stainless steel, and copper.

In some embodiments, the electrode comprising N-CNTs also comprises a copper current collector.

The electrode comprising N-CNTs may also comprise an electrically conductive additive to assist with electric current conduction. The conductive additive can construct a conductive percolation network to facilitate the absorption and retention of the electrolyte, improving the intimate contact between the lithium ions and the N-CNTs. Suitable examples of conductive additives include acetylene black, carbon black, and carbon nanofibers. The low weight, high chemical inertia, and high specific surface area of each of those additives can efficiently assist with the conductivity capability of the electrode, thereby improving the overall electrochemical performance of the hybrid supercapacitor.

The conductive additive may be provided in any amount that assists with the electric conductivity of the electrode without compromising the capacitance functionality of the N-CNTs. Suitable amounts of conductive additive in the electrode comprising N-CNTs may be less than about 20 wt. %, for example less than about 15 wt %, less than about 10 wt %, or less than about 5 wt %. In some embodiments, the conductive additive is provided in an amount of about 10 wt. %.

The electrode comprising N-CNTs may further comprise a binder. As used herein, the term “binder” refers to a substance that is capable of holding the electrode's components together by attaching to them. The binder may therefore be any binder that achieves that function. Suitable examples of binders include polyvinylidene fluoride (PVDF), polyacrylonitrile, poly(acrylic acid), polyvinylidene fluoride, poly(vinylidene fluoride-co-hexafluoropropylene), cellulose (e.g. 2-hydroxyethyl cellulose, carboxy methyl cellulose), poly(tetrafluoroethylene), polyethylene oxide, polyimide, polyethylene, polypropylene, polyacrylates, rubbers (e.g. ethylene-propylene-diene monomer rubber, or styrene butadiene rubber) copolymers thereof, and a mixture thereof.

The binder may be provided in any amount that achieves cohesion of the electrode's components without compromising the electrical characteristics of the electrode. In some embodiments, the binder is provided in an amount of less than about 20 wt. %, for example less than about 15 wt. %, less than about 10 wt. %, or less than about 5 wt. %. In some embodiments, the binder is provided in an amount of about 10 wt. %.

The electrode comprising N-CNTs may be capable of supporting a current density of at least 10 mAh/g, at least 55 mAh/g, at least 100 mAh/g, at least 250 mAh/g, at least 500 mAh/g, or at least 750 mAh/g when in a half-cell configuration. For example, the electrode comprising N-CNTs may be capable of supporting a current density of up to 1,000 mAh/g when in half-cell configuration. By specifying that the an electrode can “support” a certain current density is meant the electrode per se is subject to that current density characteristic during a state in which electric current is flowing through it.

By the electrode being in “half-cell” configuration is meant that the electrode is part of an electrochemical cell with a counter electrode, and the electrode functions in that cell as a working electrode. In particular, when the electrode comprising N-CNTs is used as the negative electrode a half-cell configuration, the electrodes support a small potential difference (e.g. less than about 1V) during polarisation and electrical charge can only be extracted from the cell during discharge to a negative cell voltage. For example, the electrode comprising N-CNTs may be used in a half-cell configuration when combined with a lithium electrode (which functions as the reference cathodic electrode).

The charge/discharge characteristics of the electrode comprising N-CNTs may be evaluated by having the electrode in a half-cell configuration, and expressed in terms of specific capacity (or current density) relative to the C-rates used in charge/discharge cycles of the half-cell. By the expression “C-rate” is meant the rate at which a battery is discharged relative to a given discharge current. For example, for a given discharge current a C-rate value of 1 means that the given discharge current will discharge the entire battery in 1 hour.

In some embodiments, the electrode comprising N-CNTs has a specific capacity of at least 35 mAh/g at about 9 C-rate. In some embodiments, the hybrid supercapacitor has a specific capacity of at least 250 mAh/g at about 0.25 C-rate.

The electrode comprising N-CNTs also ensures that high capacitance can be maintained for an elevated number of charge/discharge cycles. For example, when in half-cell configuration the electrode comprising N-CNTs provides after 1000 charge/discharge cycles for a capacitance of that is at least 70% the capacitance after the first charge/discharge cycle. In some embodiments, when in half-cell configuration the electrode comprising N-CNTs provides after 1000 charge/discharge cycles for a capacitance of that is at least 80%, at least 85%, at least 90%, at least 95% the capacitance after the first charge/discharge cycle.

N-CNTs for use in the hybrid supercapacitor of the invention may be obtained in accordance with any method known to a skilled person.

For example, CNTs may first be synthesised and subsequently doped with nitrogen in a post-synthesis doping procedure. CNTs may be manufactured using any technique known to the skilled person. Suitable techniques that may be adopted for the synthesis of CNTs include Plasma Enhanced Chemical Vapor Deposition (PECVD), Thermal Chemical Vapor Deposition (TCVD), electrolysis-based processes, and flame synthetic procedures. The subsequent doping with nitrogen may be performed, for example, by exposing the pre-formed CNTs to hot vapours of a nitrogen source compound (e.g. NH₃, NH₂NH₂, C₅H₅N, C₄H₅N, CH₃CN) at high temperature.

Alternatively, any of the chemical vapour deposition techniques mentioned above may be adapted to provide the direct growth of N-CNTs, for example by contemporaneous exposure of a substrate to both a carbon and a nitrogen precursor gas. A typical procedure in that regard would comprise steps of: forming a catalyst metal layer on a substrate; loading a substrate having the catalyst metal layer into a reaction chamber; forming a plasma atmosphere in the reaction chamber; and forming nitrogen-doped carbon nanotubes on the catalyst metal layer by supplying a carbon precursor and a nitrogen precursor into a reaction chamber at a suitable reaction temperature. For example, the reaction chamber may be maintained at a temperature in a range of between about 400° C. and about 600° C. while N-CNTs form. The carbon precursor gas may be at least one of C₂H₂, CH₄, C₂H4, C₂H6, CO, and C₂H₅OH. The nitrogen precursor gas may be at least one of NH₃, NH₂NH₂, C₅H₅N, C₄H₅N, and CH₃CN. The catalyst metal layer may be formed of Ni, Co, Fe and/or the like, or alloys thereof.

As a further alternative, N-CNTs may be obtained by carbonising polyaniline nanotubes (PANi-NTs). PANi-NTs can be synthesised by chemical oxidation of aniline monomers in solution. In a typical procedure, polymerisation of aniline monomers would be promoted by an oxidizing agent. Suitable oxidizing agents for that purpose include ammonium persulfate (APS), potassium persulfate iron chloride, potassium permanganate, and potassium dichromate.

PANi-NTs may subsequently be thermally carbonized to form N-CNTs. Suitable carbonization temperature may be in the range of from about 800° C. to about 1,200° C. Carbonization may be performed to any extent that would provide N-CNTs that are fit for purpose. For example, carbonization time may be up to about 36 hours, for example 12 hours.

The polymerisation and carbonization conditions may be tuned to control and modulate the amount of nitrogen in the resulting N-CNTs. In that regard, it was observed that a particular sequence of synthesis steps ensures the synthesis of PANi-NTs that provide, upon carbonization, N-CNTs with an amount of nitrogen that is higher than that achieved using conventional routes.

Accordingly, the present invention can also be said to provide a method for the synthesis of polyaniline nanotubes (PANi-NTs) comprising the steps of (i) providing, under stirring conditions, a solution of aniline monomers and an oxidizer at a pH of less than 7, (ii) stirring the solution for a stirring time of from 1 second to 1 minute, and subsequently (iii) leaving the solution unstirred for a time of from 6 hours to 24 hours at a temperature of from 15° C. to 25° C. The synthesis advantageously provide for PANi-NTs that provide, upon carbonization, N-CNTs with an amount of 5.8 at. % nitrogen and 1.8 at. % sulphur.

A pH of less than 7 may be achieved by any means known to a skilled person. In some embodiments, a pH of less than 7 is achieved by adding an organic acid to the solution of aniline monomers and oxidizer. The organic acid may be any organic acid that would be suitable to bring the pH of the solution to less than 7. Examples of organic acids that are suitable for use in the method of the invention include acetic acid, oxalic acid, citric acid, and succinic acid.

The amount of organic acid would be any amount that would ensure a pH of less than 7. In some embodiments, the organic acid in the solution of aniline monomers and oxidizer has a concentration of from about 0.025 M to about 1 M.

The aniline monomer may be used in any amount that would be suitable for the production of PANi-NTs. For example, the aniline monomer may be provided in an amount of from about 0.1 M to about 0.3 M.

The oxidizer may be any compound that can oxidise aniline monomers to form polyaniline. Examples of suitable oxidizers include ammonium persulfate (APS), potassium persulfate iron chloride, potassium permanganate, and potassium dichromate. The concentration of the oxidants can be changed from about 0.01 M to about 0.5 to get nanotubular structure.

Reaction temperature is one of the crucial parameters that can control the length of the polymer chains. The temperature can be adjusted using water or oil path between about 0° C. to about 35° C.

An electrode comprising N-CNTs that would be suitable for use in the supercapacitor of the invention may be obtained by any means known to a skilled person.

For example, N-CNTs may be formed directly on the surface of a suitable current collector by any of the vacuum deposition techniques described herein. In those instances the current collector may function as the substrate onto which the N-CNTs are formed. Alternatively, the N-CNTs may be pre-formed through a PANi-NTs synthesis route of the kind described herein. The so formed N-CNTs may subsequently be deposited on the surface of a suitable current collector. The deposition may be performed by either depositing the N-CNTs directly on the current collector, or by first blending the N-CNTs with an appropriate binder an, optionally, conductive additive) and subsequently depositing the blend directly on the current collector.

The hybrid capacitor of the invention has an electrode comprising an electrically conductive graphene material.

The expression “graphene material” is used herein according to its broadest meaning of an allotrope of carbon having a sheet structure of typically sp²-bonded carbon atoms that mostly form a honeycomb two-dimensional crystal lattice. The covalently bonded carbon atoms typically form repeating units that comprise 6-membered rings. By the graphene material being “electrically conductive”, the graphene material has an electrical resistivity of less than about 350 kΩ/cm². Accordingly, it will be understood that the expression “electrically conductive graphene material” encompasses pristine graphene (e.g. exfoliated directly from graphite), reduced graphene oxide (rGO), and synesthetic produced graphene (e.g. from plasma or CVD). Provided they are electrically conductive, other type of graphene materials may be included in the expression (e.g. porous graphene materials, functionalized graphene materials, etc.). It will therefore be understood that the expression does not encompass non-conductive graphene materials such as graphene oxide (GO).

Accordingly, in some embodiments the hybrid capacitor of the invention has an electrode comprising an electrically conductive graphene material selected from graphene, rGO, and a combination thereof.

The graphene material of the present invention may be produced by any means known to the skilled person. Illustrative but non-limiting methods for producing a graphene material comprising rGO include, for example, thermal deoxygenation of GO, chemical deoxygenation of GO, photochemical deoxygenation of GO, and a combination thereof. Typically, chemical deoxygenation may be accomplished by treatment of a graphene oxide with reductants such as, for example, hydrogen gas or hydrazine. Also, thermal deoxygenation can be accomplished by heating a graphene at a temperature that is sufficient to remove its oxygen functionalities (e.g. a temperature greater than about 1000° C., for about 10 minutes or more). In some embodiments, the electrically conductive graphene material is selected from chemically reduced graphene oxide, thermally reduced graphene oxide, and photo-chemically reduce graphene oxide.

As an electrode material, electrically conductive graphene materials of the kind described herein have many advantages, including high surface area and porous structure, high electric conductivity, and high chemical and thermal stability, etc. Compared with other electrode materials, such as activated carbon, graphite, and metal oxides, electrically conductive graphene material-based materials with 3D open frameworks show higher effective specific surface area, better control of channels, and higher conductivity.

The electrode comprising an electrically conductive graphene material functions as a positive electrode, i.e. a cathode. As used herein, and as a person skilled in the art would know, the expression “positive electrode” refers to the electrode at which electrons enter the supercapacitor during discharge. By reference to its functionality during discharge, the positive electrode is also commonly referred to in the art as a “cathode”.

In some embodiments, the electrically conductive graphene material is provided in the form of a graphene film. By the electrically conductive graphene material being in the form of a “film” is intended to mean that graphene is provided as a three-dimensional collection of graphene-based sheets arranged relative to each other in a substantially planar manner so as to form a layered structure or matrix having thickness, length and width dimensions. The thickness of the layered structure will typically be considerably smaller than both of its length and width dimensions so as to provide for conventional film-like dimension characteristics. In these embodiments the electrically conductive graphene material may be provided on a suitable electrode support, for example a current collector of the kind described herein.

There is no particular limitation on the thickness of the electrically conductive graphene material-based film, provided the resulting electrode is fit for purpose. In one embodiment, the electrically conductive graphene material-based film may have a thickness of at least about 20 μm, or at least about 40 μm, or at least about 50 μm, or at least about 60 μm, at least about 80 μm, or at least about 100 μm. In a further embodiment, the electrically conductive graphene material-based film has a thickness ranging from about 20 μm to about 100 pm.

Electrically conductive graphene material-based films in accordance with the invention may also have a thickness of less than about 20 μm, or less than about 10 μm, or less than about 5 μm, or less than about 1 μm, or less than about 800 nm, or less than about 500 nm, or less than about 250 nm, or less than about 100 nm, or less than about 50 nm, or less than about 10 nm. In one embodiment, the electrically conductive graphene material-based film has a thickness ranging from about 10 nm to about 20 μm.

The thickness of the electrically conductive graphene material-based film is the average thickness of the film as defined by a collective of electrically conductive graphene material-based sheets arranged relative to each other in a substantially planar manner so as to form a layered structure.

In the hybrid supercapacitor of the invention electrolyte ions may be transported to and from the electrode comprising electrically conductive graphene material by any means known to a skilled person. For example, the electrode comprising an electrically conductive graphene material may be associated with an electrically conductive current collector to facilitate the flow of electrons between the electrode and an external circuit connected to the hybrid supercapacitor. A suitable current collector may comprise a metal structure, such as a metal foil or a metal grid onto which the electrically conductive graphene material is provided in electrical contact. In that regard, the current collector may be made of any material suitable to conduct electricity. In some embodiments, the electrode comprising an electrically conductive graphene material also comprises a current collector formed from at least one of nickel, aluminium, stainless steel, and copper. In some embodiments, the electrode comprising an electrically conductive graphene material also comprises an aluminium current collector.

In some embodiments, the electrode comprising an electrically conductive graphene material also comprises a conductive additive. For example, the electrode comprising an electrically conductive graphene material may also comprise a conductive additive of the kind described herein.

In some embodiments, the electrode comprising an electrically conductive graphene material also comprises a binder. For example, the electrode comprising an electrically conductive graphene material may also comprise a binder of the kind described herein.

An electrode comprising an electrically conductive graphene material that would be suitable for use in the supercapacitor of the invention may be obtained by any means known to a skilled person. The electrode firstly can be prepared through freeze-drying of graphene oxide solutions with different concentrations ranged from 2 to 10 mg/ml, to get graphene oxide foam. This graphene oxide foam can be compressed and treated chemically or thermally to get reduced graphene oxide foam with high porosity and high specific surface area for more lithium ions accommodation.

Typically, in the lithium-ion hybrid supercapacitor of the invention lithium ions are provided by an electrolyte that contains lithium ions and that is in intimate contact with the electrodes. As used herein, an “electrolyte” means a substance that is electronically insulating but ionically conductive. As such, in the context of the present invention the electrolyte facilitates the exclusive transfer of lithium ions between electrodes by providing a separate and isolated pathway to cations relative to electrons. Typically, the requirements for a good electrolyte include a wide voltage window, high electrochemical stability, high ionic concentration and low solvated ionic radius, low resistivity, low viscosity, low volatility, low toxicity, low cost, and availability at high purity.

Electrolytes suitable for use in the present invention may be any electrolytes that would be suitable to facilitate lithium-ion ionic conduction. For example, the electrolyte may be an electrolyte solution obtained by combining a lithium salt and a solvent.

By “lithium salt” is meant a compound made up of a lithium ion (cation) and a counter anion, which can provide for lithium ions when in solution. In that regard, by the expression “counter anion” is meant a negatively charged ion that is associated with the lithium ion (cation) to provide for charge neutrality of the resulting lithium salt.

Provided the requirements of the invention are met, there is no particular limitation on the type of counter anion that can be used. Examples of suitable counter anions include BF4⁻, PF₆⁻, BF₄⁻, ClO₄⁻, N(CN)₂⁻, (CF₃SO₂)₂N⁻, (FSO₂)₂N⁻, OCN⁻, SCN⁻, dicyanomethanide, carbamoyl cyano(nitroso)methanide, (C₂F₅SO₂)₂N⁻, (CF₃SO₂)₃C⁻, C(CN)₃⁻, B(CN)₄⁻, (C₂F₅)₃PF₃⁻, alkyl-SO₃⁻, perfluoroalkyl-SO₃⁻, aryl-SO₃⁻, I⁻, H₂PO₄⁻, HPO₄²⁻, sulfate, sulphite, nitrate, trifluoromethanesulfonate, p-toluenesulfonate, bis(oxalate)borate, acetate, formate, gallate, glycolate, BF₃(CN)⁻, BF₂(CN)₂⁻, BF(CN)₃⁻, BF₃(R)⁻, BF₂(R)₂⁻, BF(R)₃⁻ where R is an alkyl group (for example methyl, ethyl, propyl), cyclic sulfonyl amides, bis (salicylate)borate, perfluoroalkyltrifluoroborate, chloride, bromide, and transition metal complex anions (for example [Tb(hexafluoroacetylacetonate)_{4]}).

Accordingly, in some embodiments the lithium salt is selected from Li[PF₂(C₂O₄)₂]1, Li[N(CF₃SO₂)₂], Li[C(CF₃SO₂)₃], Li[N(SO₂C₂F₅)₂], LiClO₄, LiPF₆, LiAsF₆, LiBF₄, LiB(C₆F₅)₄, LiB(C₆H₅)₄, Li[B(C₂O₄)₂], Li[BF₂(C₂O₄)], or a mixture of any two or more thereof.

The solvent used to obtain the electrolyte may be any solvent capable to dissolve the lithium salt. Depending on the lithium salt, the solvent for use in the electrolyte may therefore be an organic or inorganic solvent. Examples of suitable inorganic electrolyte solvents include SO₂, SOCl₂, SO₂Cl₂, and the like, and a mixture of any two or more thereof. Examples of suitable organic electrolyte solvents include dimethyl carbonate (DMC), ethyl methyl carbonate (EMC), diethyl carbonate (DEC), methyl propyl carbonate (MPC), ethyl propyl carbonate (EPC), ethylene carbonate (EC), propylene carbonate (PC), dipropyl carbonate (DPC), bis(trifluoroethyl)carbonate, bis(pentafluoropropyl)carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, perfluorobutyl ethyl carbonate, fluorinated oligomers, methyl propionate, butyl propionate, ethyl propionate, sulfolane, 1,2-dimethoxyethane, 1,2-diethoxyethane, tetrahydrofuran, 1,3-dioxolane, 4-methyl-1,3-dioxolane dimethoxyethane, triglyme, dimethylvinylene carbonate, tetraethyleneglycol, dimethyl ether, polyethylene glycols, sulfones, and gamma-butyrolactone (GBL), vinylene carbonate, chloroethylene carbonate, methyl butyrate, ethyl butyrate, ethyl acetate, gamma-valerolactone, ethyl valerate, 2-methyl-tetrahydrofuran, 3-methyl-2-oxazolidinone, 1,3-dioxolane, 4-methyl-1,3-dioxolane, vinylethylene carbonate, 2-methyl-1,3-dioxolane, and a mixture of any two or more thereof. In some embodiments, the solvent is water.

In some embodiments, the electrolyte is a solution of lithium hexafluorophosphate (LiPF₆) in ethylene carbonate (EC). An electrolyte based on ethylene carbonate as the solvent electrolyte can be particularly advantageous to improve cycling performance at high voltage.

The electrolyte may contain any amount of lithium ion conducive to the hybrid supercapacitor being fit for purpose. For example, the electrolyte may contain lithium ions at a concentration of at least about 1 mol %, at least about 10 mol %, at least about 15 mol %, at least about 20 mol %, at least about 25 mol %, at least about 30 mol %, at least about 35 mol %, at least about 40 mol %, at least about 45 mol %, or at least about 50 mol %. In some embodiments, the electrolyte contains lithium ions at a concentration of from about 1 mol % to about 100 mol %.

In some embodiments, the hybrid supercapacitor comprises an ion-permeable separator interposed between the electrodes. The function of the ion-permeable separator is that of providing electrical insulation between the electrodes while allowing for ions to diffuse to and from each electrode. As such, a suitable separator for use in the hybrid supercapacitor of the invention would be one that is made of an electrically insulating material which allows at least lithium ion diffusion between the two electrodes.

The separator may be made of any material that ensures (i) electric insulation and (ii) lithium ion conduction between the electrodes. For example, the separator may be formed from a polymer material or ceramic-polymer composite, for example celgard membrane and glass-fiber. Those latter composite separators are advantageous in that they can provide for thermal stability and can significantly reduce fire risk.

The hybrid supercapacitor can support a high current density at the negative electrode. By specifying that the hybrid supercapacitor can “support” a certain current density at the negative electrode is meant the hybrid supercapacitor per se attains that current density characteristic during a state in which electric current is flowing through the negative electrode. As known in the art, such intrinsic characteristics of a supercapacitor device are typically referenced in the context of the supercapacitor during its operation. However, by specifying the hybrid supercapacitor per se attains that characteristic is not intended to be a limitation to the hybrid supercapacitor in use. Provided the hybrid supercapacitor can attain the characteristic, the hybrid supercapacitor will of course be able to “support” that characteristic whether or not in use.

In this context, reference to the hybrid supercapacitor that “supports” or is “capable of supporting” a certain current density at the negative electrode is meant that when in a state in which electric current is flowing through the negative electrode the hybrid supercapacitor allows that certain current density to flow through the negative electrode without compromising the electrochemical integrity of the hybrid supercapacitor.

Accordingly, reference to the hybrid supercapacitor either supporting or being capable of supporting a certain current density at the negative electrode relates to the ability of the hybrid supercapacitor per se to attain the current density characteristic when, for example, the hybrid supercapacitor is connected to an external electrical component or portion of an electric circuit that provides or consumes electric power, such as a power supply or an electric load. Those skilled in the art could readily seek out suitable power supplies or electric loads that would generate, when connected to the hybrid supercapacitor of the invention, electric current flowing through the negative electrode.

A hybrid supercapacitor according to the invention will of course support the current density characteristic when in use.

The hybrid supercapacitor may be capable of supporting a current density at the negative electrode of at least 10 mAh/g, at least 55 mAh/g, at least 100 mAh/g, at least 250 mAh/g, at least 500 mAh/g, or at least 750 mAh/g. For example, the hybrid supercapacitor is capable of supporting a current density at the negative electrode of up to 1,000 mAh/g.

The hybrid supercapacitor of the invention can undergo a large number of charge/discharge cycles with no significant loss of capacity. By the hybrid capacitor having undergone a “charge/discharge cycle” is intended to mean the hybrid supercapacitor has been subjected to a two-step cycle comprising: step 1 in which electric current of a certain density flows through the negative electrode along an initial direction until at least 90% of the supercapacitor maximum capacity is reached; and step 2 in which the electric current is switched to flow through the negative electrode along the direction opposite to the initial direction until less than 10% of the supercapacitor maximum capacity is reached. A skilled person will know the technical meaning of the expression “charge/discharge cycle”, and how to perform such procedure.

The charge/discharge characteristics of the hybrid supercapacitor may be described herein with reference to tests performed at different C-rates. In some embodiments, the hybrid capacitor has a specific capacity of at least 35 mAh/g at about 9 C-rate. In some embodiments, the hybrid supercapacitor has a specific capacity of at least 250 mAh/g at about 0.25 C-rate.

In some embodiments, the hybrid supercapacitor is capable of supporting a specific current at the negative electrode of from 0.1 A/g and 15 A/g. For example, the hybrid supercapacitor may be capable to support a specific current at the negative electrode of from about 0.1 A/g to about 10 A/g, from about 0.5 A/g to about 10 A/g, from about 1 A/g to about 7.5 A/g, from about 1 A/g to about 5 A/g.

In addition, the hybrid supercapacitor is capable of operating over a broad range of voltages. In some embodiments, the hybrid supercapacitor is capable of operating at a voltage of from about 0.01V to about 9V, from about 0.01V to about 4.5V, from about 0.01V to about 3V, or from about 0.01V to about 2.5V.

Also, the hybrid supercapacitor can display remarkable energy and power density over conventional devices.

In some embodiments, the hybrid supercapacitor has an energy density of at least about 50 Wh/kg, at least about 100 Wh/kg, or at least about 200 Wh/kg. For example, the hybrid supercapacitor may have an energy density of from about 200 Wh/kg to about 400 Wh/kg, or of from about 200 Wh/kg to about 300 Wh/kg.

Also, the hybrid supercapacitor may have a power density of at least about 100 W/kg. In some embodiments, the hybrid supercapacitor has a power density of from about 100 W/kg to about 15,000 W/kg, from about 250 W/kg to about 15,000 W/kg, from about 500 W/kg to about 15,000 W/kg, from about 500 W/kg to about 10,000 W/kg, or from about 750 W/kg to about 10,000 W/kg. For example, the hybrid supercapacitor may have a power density of from about 400 W/kg to about 1,000 W/kg.

Advantageously, the hybrid supercapacitor of the invention can combine high energy density and power density. For example, the hybrid supercapacitor may have an energy density of at least about 50 Wh/kg and a power density of at least about 300 W/kg. In some embodiments, the hybrid supercapacitor has an energy density of at least about 50 Wh/kg and a power density of at least about 1,000 W/kg. For example, the hybrid supercapacitor may have an energy density of from about 50 Wh/kg to about 300 Wh/kg and a power density of from about 400 W/kg to about 10,000 W/kg.

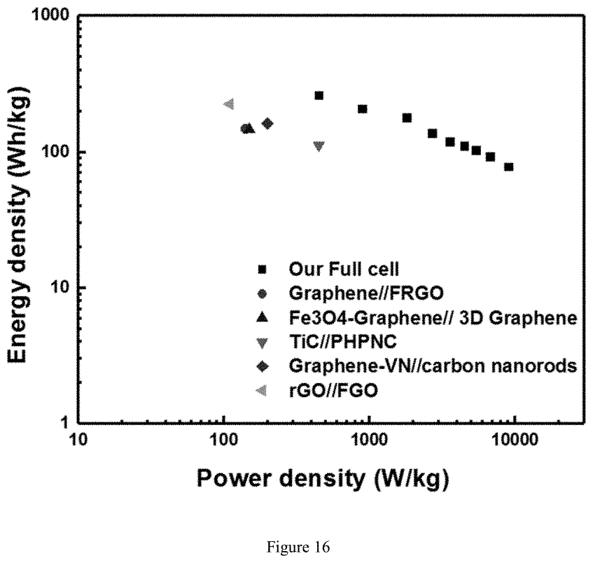

The combined high energy density and high power density places the hybrid supercapacitor of the invention ahead of existing hybrid supercapacitors. As shown in FIG. 16, the combined energy and power density of the hybrid supercapacitor of the invention is superior to those of reported graphene//functionalized reduced graphene oxide (FRGO) cells, Fe₃O₄-graphene//3D graphene cells, TiC//pyridine-derived hierarchical porous nitrogen-doped carbon (PHPNC) cells, graphene-VN//carbon nanorods cells, and rGO//functionalized GO cells.

The hybrid supercapacitor also displays remarkable cycling stability. For example, the hybrid supercapacitor has a capacity retention of at least 80% after at least 2,000 cycles. For example, the hybrid supercapacitor may have a capacity retention of at least 90% after 4,000 cycles.

The hybrid supercapacitors of the present invention can typically store 10 to 100 times more energy per unit volume or mass than electrolytic capacitors, can accept and deliver charge much faster than conventional rechargeable batteries, and tolerate many more charge and discharge cycles than conventional rechargeable batteries.

In the hybrid supercapacitor of the invention the combination of the specific electrodes provides an opportunity to achieve both high energy and power densities without compromising the cycling stability and affordability. Also, the hybridization of the two electrodes can further broaden the operating voltage and increase the capacitance of the hybrid capacitor.

The hybrid supercapacitor of the present invention can also be an appealing candidate for applications requiring many rapid charge/discharge cycles rather than long term compact energy storage, for example win cars, buses, trains, cranes and elevators, where they are used for regenerative braking, short-term energy storage or burst-mode power delivery. Other applications include sensors, capacitive water desalination, electrocatalysis, and electro resistive heating.

### EXAMPLES

### Example 1

### Synthesis of N-CIVTs

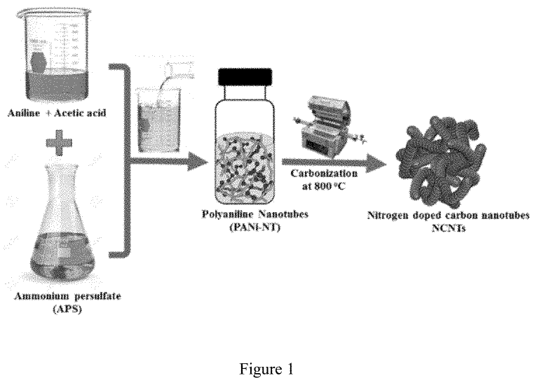

A schematic of a synthesis procedure adopted for the production of N-CNTs is shown in FIG. 1. N-CNTs were prepared by carbonization of polyaniline nanotubes (PANi-NT). PANi-NT was prepared by rapid-mixing aniline and ammonium persulfate (APS) solutions in presence of acetic acid, followed by vigorous stirring for 20 seconds. The concentration of aniline, APS and acetic acid were changed from 0.01 to 0.3 M, 0.015 to 0.35 M and from 0.05 to 0.5 M, respectively to optimize the PANi-NT structure. The reaction mixture was subsequently left without stirring for 12 hours. The reaction conditions were optimized by changing the reactants concentrations (aniline, ammonium persulfate and acetic acid) several times to get PANi in tubular structure.

After washing and drying, the PANi-NT was carbonized at different temperatures from 800° C. to 1,200° C. for 12 hours, thereby obtaining N-CNTs.

### Example 2

### Characterization of N-CNTs

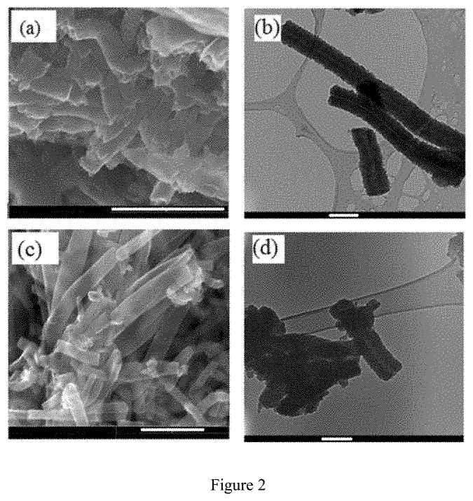

Ultra-long open-end nitrogen-doped carbon nanotubes (N-CNTs) were prepared by pyrolysis of polyaniline nanotubes (PANi-NT) under N₂ atmosphere. FIG. 2 SEM and TEM images of PANi-NT (FIGS. 2(a) and 2(b), respectively) and N-CNTs (FIGS. 2(c) and 2(d), respectively) obtained after carbonization of the PANi-NTs. The image allows appreciating a number of nanotubes having an average axial length of a few microns. The PANi-NT polymer is observed to keep its shape after carbonization, with smooth surfaces and transparent enough to confirm the hollow nature of the nanotubes.

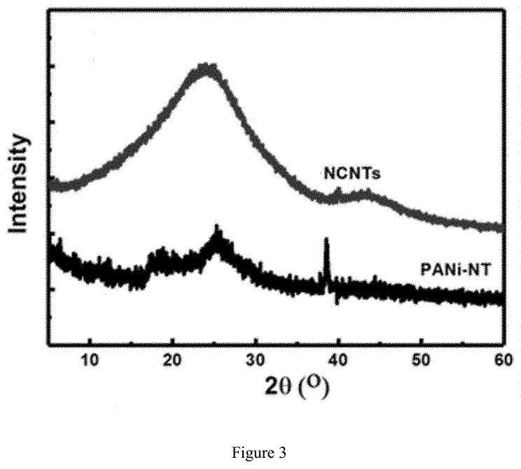

FIG. 3 shows X-Ray Diffraction (XRD) patterns of PANi-NT and N-CNTs. The characteristic diffractions of PANi-NT are centred at 2θ values of 20.1° and 25.3°, which attribute to the crystallinity and the coherence length of aligned polymer chains. N-CNTs have two broad diffraction peaks near 25° and 43°, which confirm the graphitic layer structure or graphene interlayer space of N-CNTs. This structure can be beneficial for energy storage applications due to the easy transportation of ions from electrolyte.

TABLE 1
Summary of X-ray photoelectron spectroscopy
(XPS) data of PANi-NT and N-CNTs anode

| Sample | % C | % O | C/O | % N | % S |
|---|---|---|---|---|---|
| PANi nanotubes | 75.3 | 13.0 | 0.058 | 8.9 | 2.8 |
| (PANi-NT) | | | | | |
| Nitrogen doped | 90.4 | 2.0 | 0.45 | 5.8 | 1.8 |
| carbon nanotubes | | | | | |
| (NCNTs) | | | | | |

X-ray photoelectron spectroscopy (XPS) was used to determine the percentage of each element in our anode materials before and after carbonization (Table 1). XPS confirms the PANi nanotubes (PANi-NT) is carbonized to N-CNTs, carbon increased to 90.4%, Oxygen decreased to 2% and C/O ratio increased to 0.45. At the same time, the N-CNTs still contains 5.8% of Nitrogen after carbonization. Therefore, these optimized conditions are suitable for PANi-NT carbonization because it's observed at higher temperature the Nitrogen content was decreased.

Furthermore, XPS results reveal that N-CNTs contain Sulphur (S) of 1.8%, which compensates the reduction of nitrogen content compared to the other reported values for nitrogen doped carbon materials. The large atomic radius of Sulphur can increase interlayer spacing of the carbon matrix and create more micropores, improving the charge capacity of the N-CNTs, and also improve their reversible capacity due to the synergistic effects between Nitrogen and Sulphur atoms in the carbon structure.

### Example 3

### Electrochemical Characterizations of the Electrode Comprising N-CNTs

Therefore, each electrode has been tested separately in a half-cell configuration against lithium metal. This ensures the determination of the exact operation voltage and capacity for each electrode. One of the biggest problems for hybrid supercapacitor is the wrong mass loading for anode and cathode (the imbalance of kinetics between the two electrodes). Accordingly, the electrode comprising N-CNTs was tested as the anode electrode of a half-cell against a lithium metal electrode acting as cathode.

### Anode Electrode Preparation

The anode electrode of the half-cell test was prepared by mixing of N-CNTs as the active anode material, acetylene black as a conductive additive, and carboxy methyl cellulose as binder in the weight percentages of 80%, 10% and 10%, respectively. The mixture was stirred for 3 hours to make a homogeneous paste. Then, the mixture paste was coated on copper substrate used as current collector. After drying at 70° C. for 6 hours under vacuum, the coated superstrate was pressed by calendaring machine and cut to circular shapes to fit within a coin-cell support.

### Half-Cell Fabrication

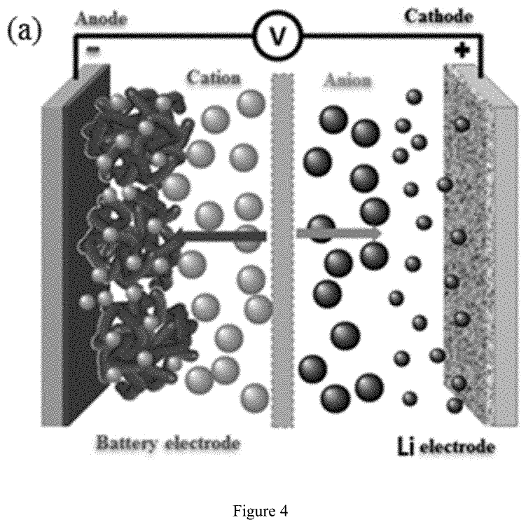

The test half-cell was assembled in highly controlled environment (glovebox). The half-cell was assembled in accordance with the schematic shown in FIG. 4. The N-CNTs coated on copper was used as anode and lithium foil was used as cathode. In this study, a fibre glass porous membrane was used as separator and lithium hexafluorophosphate solution in ethylene carbonate used as electrolyte.

### Half-Cell Electrochemical Characterization

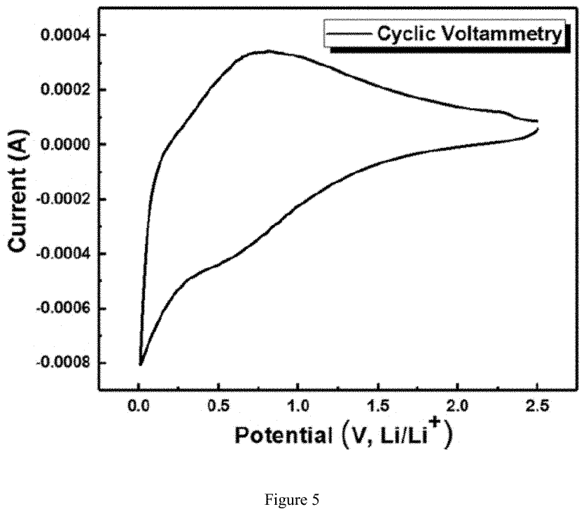

FIG. 5 shows the cyclic voltammetry of the half-cell. Cyclic voltammetry testing shows the ability of anode material to work smoothly from 0.01 to 2.5 V for Li⁺ intercalation and interaction of Li⁺ ions with N functional groups, heteroatoms and defects.

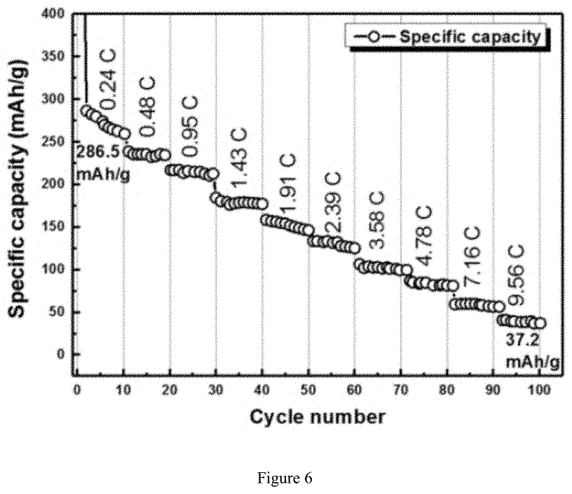

FIG. 6 illustrates the rate capability of N-CNTs anode at different current densities from C-rate 0.25 C to 9.56 C. The data indicates that the N-CNTs electrode shows excellent Li-ion storing capability and cycling stability even at high rates. The calculated reversible capacities for the anode material are 286.5 mAh/g and 37.2 mAh/g at C-rates of 0.24 C and 9.56 C, respectively.

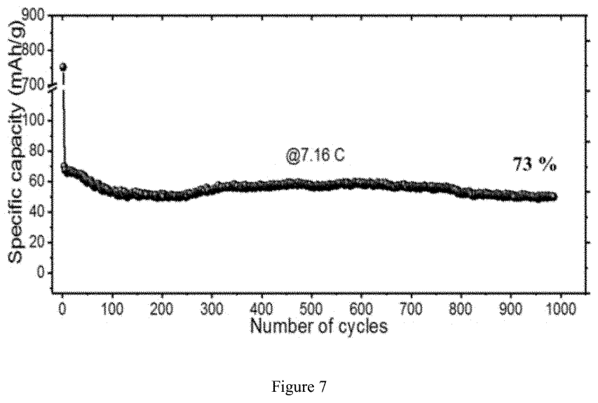

Furthermore, the cycling performance of N-CNTs was investigated at a C-rate of 7.16 C over 1,000 cycles (FIG. 7). The corresponding data demonstrates an extraordinary cycling stability during charge/discharge with a final percentage of 73% after 1,000 cycles.

### Example 4

### Electrochemical Characterizations of the Electrode Comprising an Electrically Conductive Graphene Material

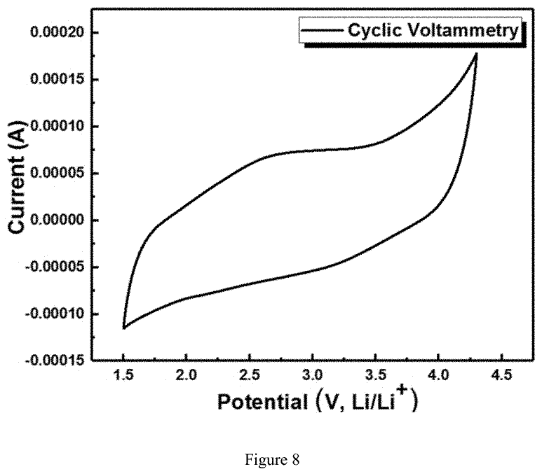

Cathode electrode was tested versus Li metal to know exact operation voltage and capacity. Cyclic voltammetry of the rGO cathode was initially measured in a Li half-cell system between 1.5 and 4.5 V vs Li/Li+. The CV curves of rGO reveal nearly rectangular shapes with small humps observed at all the scan rates measured (FIG. 8), indicating major contribution from electric double layer capacitance (EDLC) with a smaller but considerable hare from pseudo-capacitance. This pseudocapacitance must be ascribed to the presence of oxygen functional groups on PRGO nanosheets.

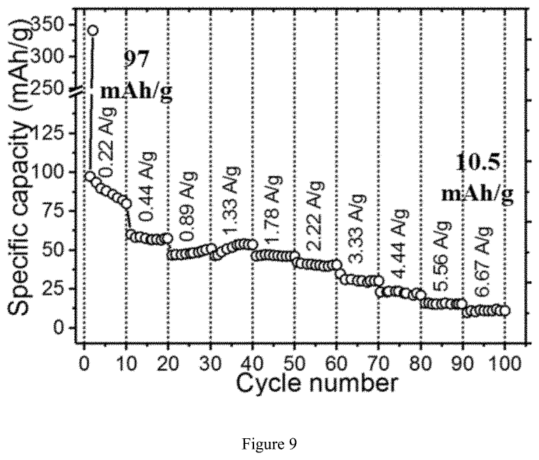

RGO cathode showed high rate capability at different current densities from 0.22 A/g to 6.67 A/g (FIG. 9). The rGO cathode shows a maximum capacity of 97 mA h/g at 0.22 A/g. Moreover, the rGO cathode still delivers a capacity of 10.5 mA h/g at very high current density of 6.67 A/g, suggesting excellent rate capabilities. This excellent performance of rGO might be attributed to the partial reduction of graphene oxide which increases electrical conductivity while maintaining a substantial amount of C/O redox groups.

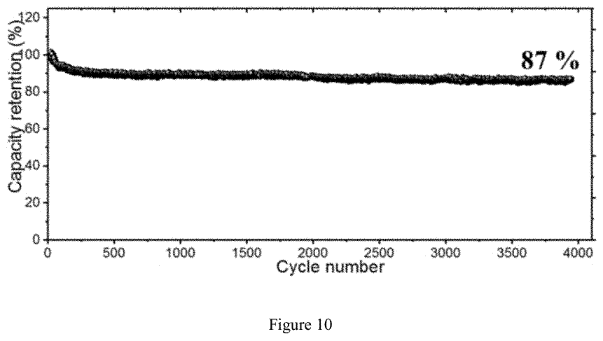

FIG. 10 represents the cycling test and reveals that after 4000 cycles, the rGO electrode retains 87% of its initial specific capacity.

### Example 5

### Electrochemical Characterizations of the Hybrid Supercapacitor

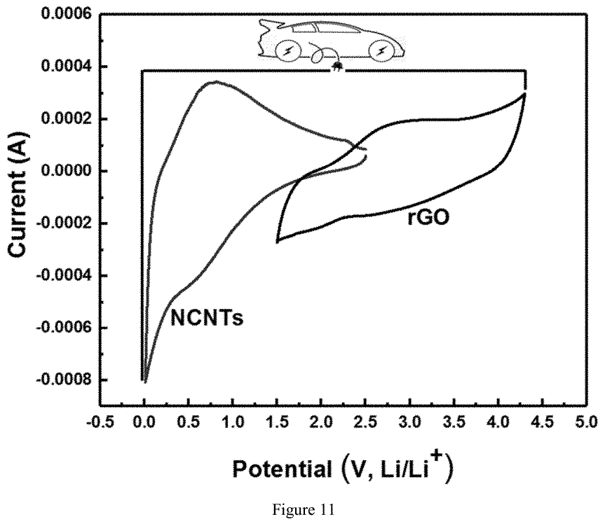

FIG. 11 represents the illustration of design of unique Li-ion capacitor with combined CV curves of NCNTs and rGO in different voltage windows such as 0.01-2.5 V and 1.5 V-4.5 V (vs Li/Li+), respectively, indicating the ability of this system to operate in lager potential widow of 0.01-4 V (full cell) based on the inclusion of different charge storing mechanisms.

Prior to assembling full LIC cell, N-CNTs and an electrically conductive graphene material were cycled 10 cycles in half-cells at fixed current density, and then the cells were disassembled in the glove box and by collecting electrodes, full cell was fabricated and tested within 0.01 to 4 V. The N-CNTs anode was fully discharged up to 0.01 V (vs. Li) before used in the full LIC cells.

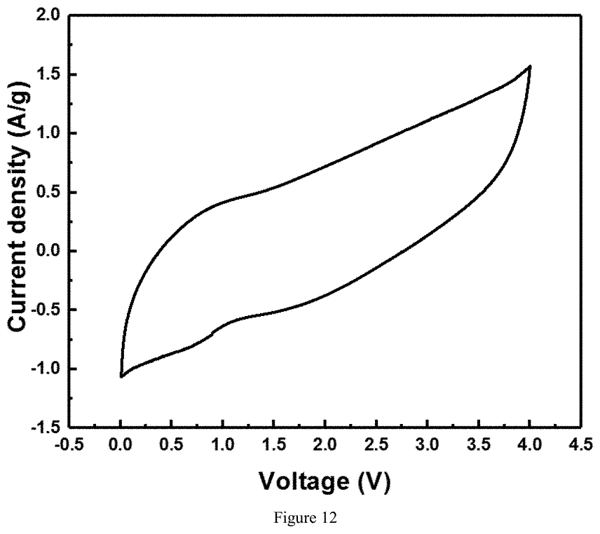

CV curve of the full cell shows a quasi-rectangular shapes (FIG. 12) and it operates perfectly from within 0.01 to 4 V without any deformation, indication the high stability of our system within this voltage range.

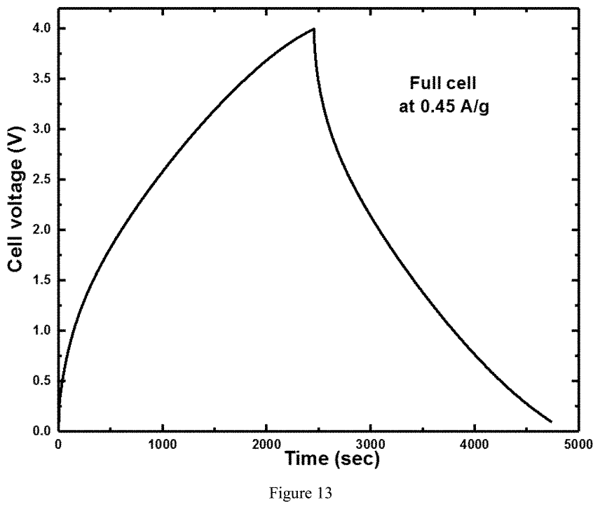

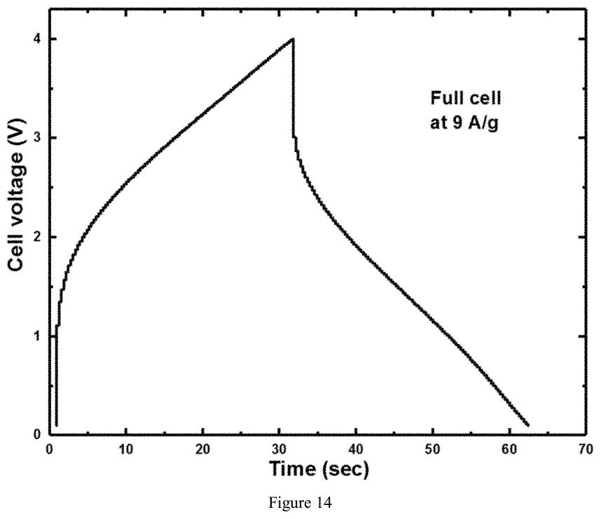

FIGS. 13 and 14 display the galvanostatic charge/discharge curves for fabricated Li-ion capacitor at lower (0.45 A/g) and higher (9 A/g) current densities, respectively. The full cell can behave as battery (FIG. 13, take long time to charge and discharge) and as supercapacitor (FIG. 14, take short time to charge and discharge).

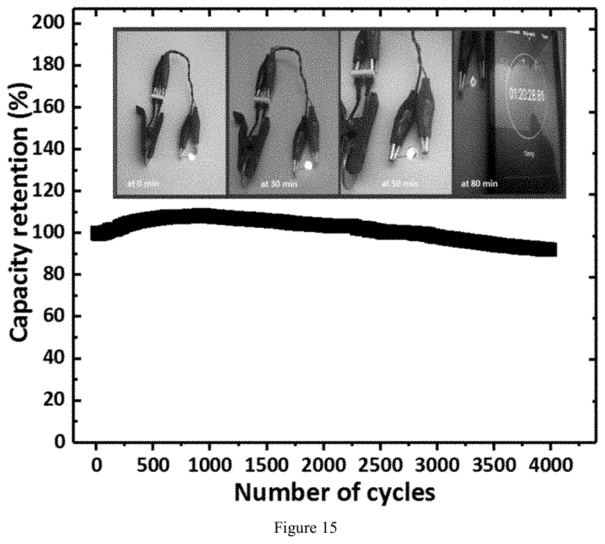

Long life stability of the full cell was tested up to 4000 charge/discharge cycles (FIG. 15), it is obvious that the performance of Li-ion capacitor improved within the first 1000 cycles due to the device activation, and then decreased slowly to 4000 cycles. The full cell delivers a significant stability of 92% after 4000 cycles, confirming excellent cyclic stability. Furthermore, the was tested to power red LED for more than 80 minutes after 30 seconds of charging (inset of FIG. 15).

The Ragone plot in FIG. 16 demonstrates the relation between calculated power density and energy density of our full cell. NCNTs//rGO full cell can provide an outstanding energy density of 257 Wh/kg at a power density of 468 W/kg, which is higher than recorded values of current Li-ion batteries. Also, the Ragone plot show a comparison between our system and reviewed values for other materials used for Li-ion capacitors to confirm the better performance of our NCNTs//rGO full cell over other Li-ion capacitors.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A lithium-ion hybrid supercapacitor comprising:
an electrode comprising nitrogen-doped carbon nanotubes (N-CNTs), and an electrode comprising an electrically conductive graphene material.

2. The supercapacitor of claim 1, wherein the N-CNTs have an atomic content of nitrogen of at least about 10%.

3. The supercapacitor of claim 1, wherein the N-CNTs have an average axial length of at least 3 μm.

4. The supercapacitor of claim 1, wherein the N-CNTs have an atomic content of oxygen of at least about 2%.

5. The supercapacitor of claim 1, comprising an electrolyte which is a solution of (i) a lithium salt selected from Li[PF₂(C₂O₄)₂], Li[SO₃CF₃], Li[N(CF₃SO₂)₂], Li[C(CF₃SO₂)₃], Li[N(SO₂C₂F₅)₂], LiClO₄, LiPF₆, LiAsF₆, LiBF₄, LiB(C₆F₅)₄, LiB(C₆H₅)₄, Li[B(C₂O₄)₂], Li[BF₂(C₂O₄)], and a mixture of any two or more thereof, and (ii) a solvent selected form dimethyl carbonate (DMC), ethyl methyl carbonate (EMC), diethyl carbonate (DEC), methyl propyl carbonate (MPC), ethyl propyl carbonate (EPC), ethylene carbonate (EC), propylene carbonate (PC), and a mixture of any two or more thereof

6. The supercapacitor of claim 1, wherein the electrode comprising N-CNTs further comprises a conductive additive.

7. The supercapacitor of claim 6, wherein the conductive additive is selected from acetylene black, carbon black, carbon nanofibers, and a combination thereof.

8. The supercapacitor of claim 1, wherein the electrode comprising N-CNTs further comprises a binder.

9. The supercapacitor of claim 8, wherein the binder is selected from polyvinylidene fluoride (PVDF), polyacrylonitrile, poly(acrylic acid), polyvinylidene fluoride, poly(vinylidene fluoride-co-hexafluoropropylene), 2-hydroxyethyl cellulose, carboxy methyl cellulose, poly(tetrafluoroethylene), polyethylene oxide, polyimide, polyethylene, polypropylene, polyacrylates, rubbers (e.g. ethylene-propylene-diene monomer rubber, or styrene butadiene rubber) copolymers thereof, and a mixture thereof

10. The supercapacitor of claim 1, wherein the electrode comprising N-CNTs has a specific capacity of at least 35 mAh/g at 9.56 C-rate when in half-cell configuration.

11. The supercapacitor of claim 1, wherein the electrode comprising N-CNTs has a specific capacity of at least 250 mAh/g at 0.24 C-rate when in half-cell configuration.

12. The supercapacitor of claim 1, wherein the electrode comprising N-CNTs has, when in half-cell configuration, a capacitance after 1000 charge/discharge cycles that is at least 70% the capacitance after the first cycle.

13. The supercapacitor of claim 1, having an energy density of at least about 50 Wh/kg.

14. The supercapacitor of claim 11, having a power density of at least about 100 W/kg.

15. The supercapacitor of claim 1, having an energy density of at least about 50 Wh/kg and a power density of at least about 300 W/kg.

16. The supercapacitor of claim 1, which is provided in the form of a coin cell, or a pouch.

17. The supercapacitor of claim 1, wherein the electrically conductive graphene material is selected from graphene, rGO, and a combination thereof
